(19) United States
(12) Patent Application Publication
(10) Pub. No.: US 2024/0353113 A1
(43) Pub. Date: Oct. 24, 2024

(54) AUTOMATIC RACK MOVEMENT FOR A DOMESTIC KITCHEN APPLIANCE

(71) Applicants: BSH Home Appliances Corporation, Irvine, CA (US); BSH Hausgeräte GmbH, Munich (DE)

(72) Inventor: John Paul Jacob Farris, New Bern, NC (US)

(21) Appl. No.: 18/135,796

(22) Filed: Apr. 18, 2023

(51) Int. Cl. F24C 15/16; A47J 36/32; A47J 36/34

(52) U.S. Cl. CPC F24C 15/16; A47J 36/32; A47J 36/34

(57) ABSTRACT

A kitchen appliance includes: a housing; a cooking chamber located in the housing; a rack moving mechanism configured to adjust a vertical height of a rack located in the cooking chamber; and a controller connected to the rack moving mechanism and configured to operate the rack moving mechanism to move the rack vertically. The controller has a plurality of heating programs, and the controller operates the rack moving mechanism to move the rack to a second vertical height from a first vertical height, the second vertical height being based on a selected one of the heating programs.

### FIELD OF THE INVENTION

The invention is directed to a domestic appliance. More particularly, embodiments of the invention are directed to automatic rack movement for a domestic cooking appliance.

An example of an application for the invention is a domestic kitchen cooking appliance in which the height of a support rack is automatically adjusted based on a cooking program.

### BACKGROUND OF THE INVENTION

Some modern domestic kitchens include cooking appliances such as, for example, ranges, stoves, and ovens. Many of these cooking appliances have a cooking chamber that is configured to receive a food item to be cooked or otherwise heated. Some such cooking appliances have a support rack inside the cooking chamber that is configured to support an item being heated or cooked in the cooking chamber.

Applicants recognized an improvement to the above arrangements and implement those improvements in embodiments of the invention.

### SUMMARY

The invention achieves the benefit of allowing a support rack to be automatically moved to a desired vertical position based on an item being heated or cooked and/or a selected heating/cooking program.

Embodiments of the invention are based on the inventor's recognition that particular cooking programs are optimized by different vertical positions of a rack that supports a food container.

Particular embodiments of the invention are directed to a kitchen appliance that includes: a housing; a cooking chamber located in the housing; a rack moving mechanism configured to adjust a vertical height of a rack located in the cooking chamber; and a controller connected to the rack moving mechanism and configured to operate the rack moving mechanism to move the rack vertically. The controller has a plurality of heating programs, and the controller operates the rack moving mechanism to move the rack to a second vertical height from a first vertical height, the second vertical height being based on a selected one of the heating programs.

In some embodiments, the rack moving mechanism includes a left side moving mechanism configured to support a left side of the rack, and a right side moving mechanism configured to support a right side of the rack.

In some embodiments, the left side moving mechanism includes two left side mechanisms, each of the left side mechanisms configured to support the rack at a different location on a left side of the rack.

In some embodiments, the right side moving mechanism includes two right side mechanisms, each of the right side mechanisms configured to support the rack at a different location on a right side of the rack.

In some embodiments, the rack moving mechanism includes a rack supporting member that is configured to support the rack, a shaft attached to the rack supporting member, and a motor attached to the shaft and configured to rotate the shaft. The rotation of the shaft causes the rack supporting member to move vertically.

Other embodiments of the invention are directed to a kitchen appliance that includes: a housing; a cooking chamber located in the housing; a rack located in the cooking chamber; a rack moving mechanism connected to the rack and configured to adjust a vertical height of the rack; and a controller connected to the rack moving mechanism and configured to operate the rack moving mechanism to move the rack vertically. The controller has a plurality of heating programs, and the controller operates the rack moving mechanism to move the rack to a second vertical height from a first vertical height, the second vertical height being based on a selected one of the heating programs.

### BRIEF DESCRIPTION OF THE DRAWINGS

The following figures form part of the present specification and are included to further demonstrate certain aspects of the disclosed features and functions, and should not be used to limit or define the disclosed features and functions. Consequently, a more complete understanding of the exemplary embodiments and further features and advantages thereof may be acquired by referring to the following description taken in conjunction with the accompanying drawings, wherein:

FIG. 1 is a perspective view of an exemplary appliance in accordance with embodiments of the disclosure;

FIG. 2 is a perspective view of a cooking chamber of the appliance of FIG. 1;

FIG. 3 is a perspective view of an exemplary lifting mechanism in accordance with embodiments of the disclosure;

FIG. 4 is a perspective view of an exemplary mounting recess in accordance with embodiments of the disclosure;

FIG. 5 is a top view of an exemplary rack in accordance with embodiments of the disclosure; and

FIG. 6 is a magnified partial view of the lifting mechanism of FIG. 3.

### DETAILED DESCRIPTION

The invention is described herein with reference to the accompanying drawings in which exemplary embodiments of the invention are shown. The invention may, however, be embodied in many different forms and should not be construed as limited to the embodiments set forth herein.

As explained above, embodiments of the invention achieve the benefit of allowing a support rack to be automatically moved to a desired vertical position based on an item being heated or cooked and/or a selected heating/cooking program.

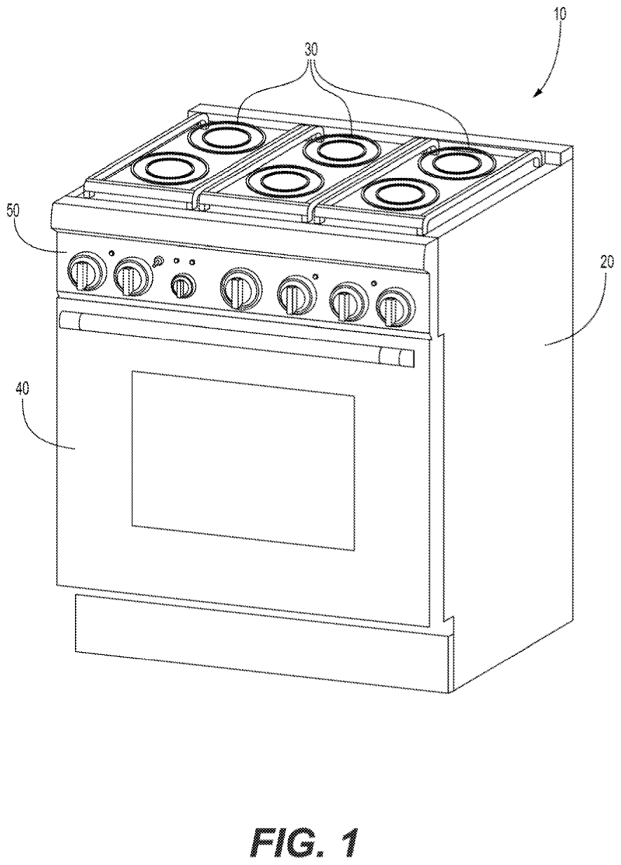

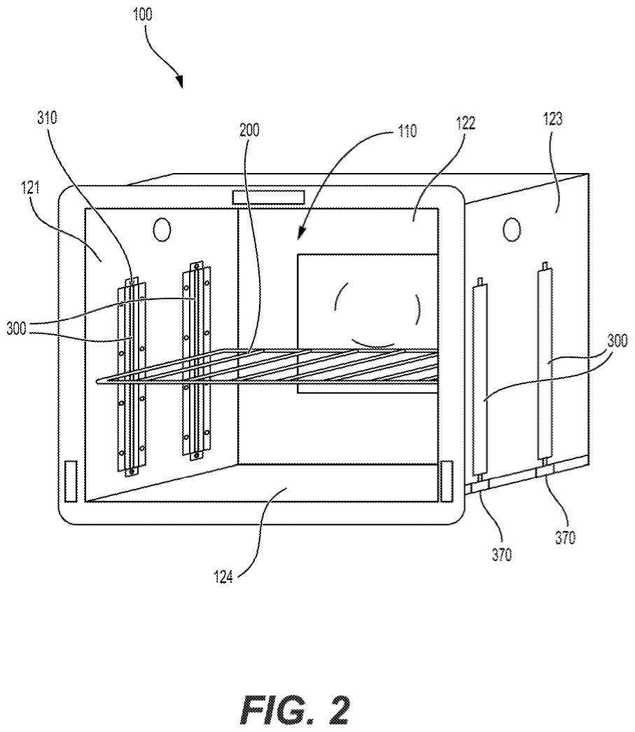

FIG. 1 shows an example of a kitchen appliance 10, in this case an oven, in accordance with embodiments of the invention. Applicant notes that the figures are schematic in nature and are not drawn to scale. Various features are depicted larger relative to other features for clarity purposes even though their actual relative sizes are different. In this example, kitchen appliance 10 includes a housing 20, a plurality of cooktop heating elements 30, and a cooking chamber 100 (FIG. 2) in which food items are heated and/or cooked. Cooking chamber 100 is accessed through a closable door 40. In this example, cooking chamber 100 has one or more heating elements (not shown) such that the temperature inside cooking chamber 100 is controllable. In some examples, the heating element is one or more gas burners, one or more electric elements, one or more other types of elements that provide heat or heating energy to cooking chamber 100, or any combination of these. A controller (in this example control panel 50) includes various controls that allow a user of appliance 10 to control temperature, cook time, and other parameters of the cooking/heating operation of cooking chamber 100, and other functions of appliance 10. The term “controller” is used herein to mean control panel 50, any other controller, or a part of control panel 50 that receives user input and sends control signals to other parts of appliance 10.

FIG. 2 shows an example of cooking chamber 100. In this example, cooking chamber 100 has a cooking area 110 that is bounded by side walls 121, 123, a back wall 122, a bottom wall 124, and a top wall. In this example, a rack 200 is supported in cooking chamber 100 to provide a support for one or more cooking vessels containing food to be heated or cooked. Also shown in FIG. 2 is a rack moving mechanism that includes, in this example, four moving mechanisms 300. Other examples include fewer or more moving mechanisms 300. Each moving mechanism 300 includes a driver 370, such as, for example, a stepper motor, explained in more detail below.

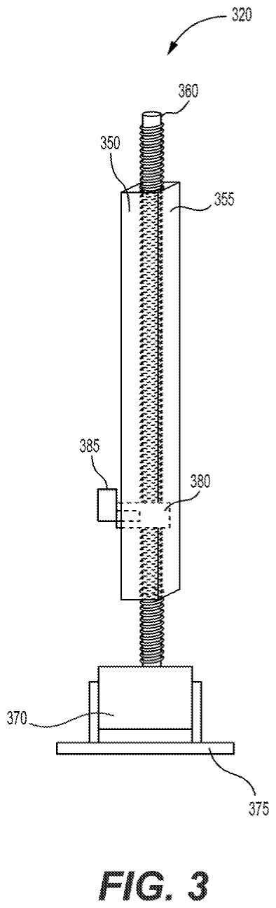

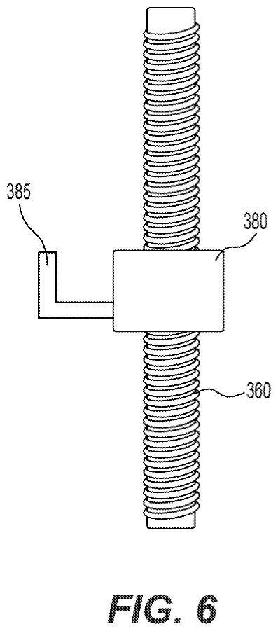

FIG. 3 shows an example of moving mechanism 300 in accordance with embodiments of the invention. In this example, moving mechanism 300 includes a shaft 360 that is rotated by driver 370. In this example, a rack supporting member 385 is attached to shaft 360 by a mount 380 and is moved up and down vertically by the rotation of shaft 360. In this example, mount 380 includes inside threads that engage threads on shaft 360. FIG. 6 shows a magnified view of shaft 360 interacting with mount 380. While shaft 360 in the example shown in FIG. 3 is threaded, other configurations can be used that cause rack supporting member 385 to move vertically within cooking chamber 100.

The example shown in FIG. 3 includes a sheath 350 that has a plurality of sides 355 that at least partially surround shaft 360. In embodiments, sheath 350 has a slot that permits rack supporting member 385 to move vertically and restricts rotation of rack supporting member 385 so that rotation of threaded shaft 360 causes rack supporting member 385 to move vertically. In the example in FIG. 3, driver 370 is a stepper motor that is mounted in a mount 375 at the bottom of shaft 360. In other embodiments, driver 370 and mount 375 are located at the top of shaft 360. One or more sensors, such as, for example, Hall sensors, can be provided to determine the location of rack supporting member 385 by monitoring the number of rotations of shaft 360, or other methods.

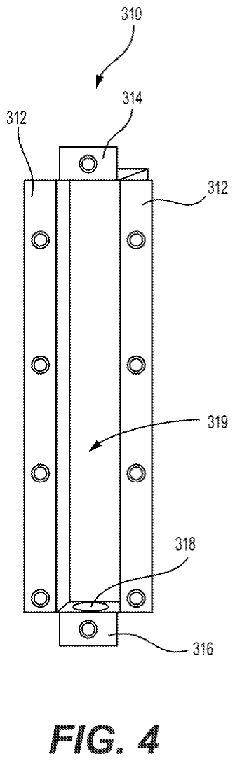

FIG. 4 shows an example of a recess 310 that is located in side wall 121, 123 of cooking chamber 100. Recess 310 is configured to house sheath 350 and at least a portion of one or more of shaft 360, rack supporting member 385, and mount 380. In this example, recess 310 has flanges 312, 314, 316 that facilitate the attachment of recess 310 to side wall 121, 123. Also shown in FIG. 4 is an interior volume 319, and an opening 318. Interior volume 319 is configured to house sheath 350 and at least a portion of one or more of shaft 360, rack supporting member 385, and mount 380. Opening 318 is provided to allow shaft 360 to penetrate recess 310, permitting driver 370 to be located outside of interior volume 319. In some examples, recess 310 is open to cooking area 110. In other examples, recess 310 is covered by an elastic sheet, for example, that includes a slit through which rack supporting member 385 extends. In embodiments, the sheet is made of two overlapping panels that separate only where rack supporting member 385 extends between them.

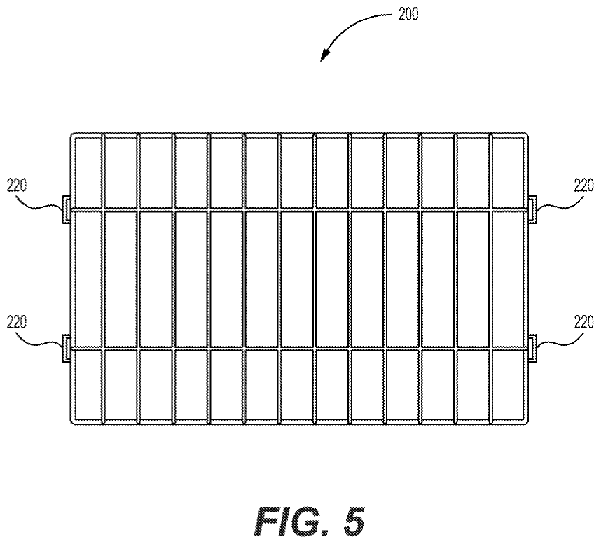

FIG. 5 shows an example of rack 200 in accordance with embodiments of the invention. In this example, rack 200 has four receiving portions 220 that each receives one of rack supporting member 385. This example of rack 200 is configured to be supported by four moving mechanisms 300. Other examples of rack 200 have a different number of receiving portions 220 that correspond to the number of moving mechanisms used. For example, an appliance 10 that is designed to heat/cook very heavy food items can have six or more moving mechanisms 300.

In embodiments, control panel 50 contains a plurality of cooking programs that are selectable by a user. Each of the cooking programs provides instructions to the various heating elements to maintain a desired temperature in cooking chamber 100 for a desired duration (and/or other parameters). Each of the cooking programs also provides instructions to driver(s) 370 to move rack 200 to a desired vertical position during the cooking operation of that cooking program. For example, cooking a pizza may be optimized by locating rack 200 in a central vertical position, while cooking french fries may be optimized by locating rack 200 in a position closer to the top of cooking chamber 100. Selection of a particular cooking program by the user results in not only the proper temperature and cooking duration (or humidity), but also the proper vertical location of rack 200.

Some cooking programs may contain multiple vertical positions of rack 200 during one cooking program. For example, a particular program may call for maintaining a temperature of 400 degrees for 30 minutes with rack 200 at a first vertical position, them maintaining a temperature of 450 degrees for 5 minutes with rack 200 at a second vertical position. Other cooking programs can have fewer or more temperatures, durations, and/or rack locations in any combination.

While the example shown includes one rack 200, other embodiments include multiple racks (such as rack 200). In some embodiments having multiple racks, each rack is moved vertically by its own set of moving mechanisms 300 that are controlled by control panel 50. Some embodiments having multiple racks include sensors and/or other devices to avoid two of the racks contacting each other.

It will be appreciated that variants of the above-disclosed and other features and functions, or alternatives thereof, may be combined into many other different systems or applications. Any of the features described above can be combined with any other feature described above as long as the combined features are not mutually exclusive. Various presently unforeseen or unanticipated alternatives, modifications, variations or improvements therein may be subsequently made by those skilled in the art which are also intended to be encompassed by the invention.

What is claimed is:

1. A kitchen appliance, comprising:
a housing;
a cooking chamber located in the housing;
a rack moving mechanism configured to adjust a vertical height of a rack located in the cooking chamber; and
a controller connected to the rack moving mechanism and configured to operate the rack moving mechanism to move the rack vertically,
wherein the controller has a plurality of heating programs, and
the controller operates the rack moving mechanism to move the rack to a second vertical height from a first vertical height, the second vertical height being based on a selected one of the heating programs.

2. The kitchen appliance of claim 1, wherein the rack moving mechanism comprises a left side moving mechanism configured to support a left side of the rack, and a right side moving mechanism configured to support a right side of the rack.

3. The kitchen appliance of claim 2, wherein the left side moving mechanism comprises two left side mechanisms, each of the left side mechanisms configured to support the rack at a different location on a left side of the rack.

4. The kitchen appliance of claim 3, wherein the right side moving mechanism comprises two right side mechanisms, each of the right side mechanisms configured to support the rack at a different location on a right side of the rack.

5. The kitchen appliance of claim 1, wherein the rack moving mechanism comprises a rack supporting member that is configured to support the rack,
a shaft attached to the rack supporting member, and
a motor attached to the shaft and configured to rotate the shaft, and
wherein the rotation of the shaft causes the rack supporting member to move vertically.

6. The kitchen appliance of claim 5, wherein the rack supporting member is configured to move the rack vertically in response to the rack supporting member moving vertically.

7. The kitchen appliance of claim 5, wherein the motor is controlled by the controller based on the selected one of the heating programs.

8. The kitchen appliance of claim 5, further comprising a recess in an inner wall of the cooking chamber, wherein the shaft is located in the recess.

9. The kitchen appliance of claim 8, wherein the rack supporting member extends from the recess.

10. The kitchen appliance of claim 8, wherein the motor is located outside of the recess.

11. The kitchen appliance of claim 4, wherein each of the left side mechanisms and each of the right side mechanisms comprises:
a rack supporting member that is configured to support the rack,
a shaft attached to the rack supporting member, and
a motor attached to the shaft and configured to rotate the shaft, and
wherein the rotation of the shaft causes the rack supporting member to move vertically.

12. The kitchen appliance of claim 11, wherein the shaft comprises an external thread, the rack supporting member comprises an internal thread, and the external thread of the shaft engages the internal thread of the rack supporting member.

13. The kitchen appliance of claim 1, wherein the selected one of the heating programs directs the controller to operate the rack moving mechanism to move the rack to a third vertical height from the second vertical height during a heating process.

14. The kitchen appliance of claim 1, further comprising a recess in an inner wall of the cooking chamber,
wherein at least a portion of the rack moving mechanism is located in the recess.

15. The kitchen appliance of claim 1, further comprising a sensor that senses the vertical height of the rack.

16. The kitchen appliance of claim 1, wherein the rack moving mechanism comprises a rotating shaft, and the sensor senses a number of times the shaft rotates.

17. A kitchen appliance, comprising:
a housing;
a cooking chamber located in the housing;
a rack located in the cooking chamber;
a rack moving mechanism connected to the rack and configured to adjust a vertical height of the rack; and
a controller connected to the rack moving mechanism and configured to operate the rack moving mechanism to move the rack vertically,
wherein the controller has a plurality of heating programs, and
the controller operates the rack moving mechanism to move the rack to a second vertical height from a first vertical height, the second vertical height being based on a selected one of the heating programs.

18. The kitchen appliance of claim 17, wherein the rack moving mechanism comprises a rack supporting member that attaches to and supports the rack,
a shaft attached to the rack supporting member, and
a motor attached to the shaft and configured to rotate the shaft, and
wherein the rotation of the shaft causes the rack supporting member to move vertically.

19. The kitchen appliance of claim 18, wherein the rack comprises a receiving portion that receives the rack supporting member.

20. The kitchen appliance of claim 17, wherein the selected one of the heating programs directs the controller to operate the rack moving mechanism to move the rack to a third vertical height from the second vertical height during a heating process.
